(19) United States
(12) Patent Application Publication
(10) Pub. No.: US 2017/0190076 A1
(43) Pub. Date: Jul. 6, 2017

(54) System and method of pouring concrete around a flexible ventilation duct assembly

(71) Applicant: MÉCANICAD INC., Rouyn-Noranda (CA)

(72) Inventors: André Paquet, Rouyn-Noranda (CA); Cristian Paquet, Rouyn-Noranda (CA)

(21) Appl. No.: 15/330,807

(22) Filed: Nov. 7, 2016

(30) Foreign Application Priority Data
Nov. 6, 2015 (CA) 2,911,584
Nov. 6, 2015 (CA) 2,911,587

(51) Int. Cl. B28B 7/00; B66D 1/60; B28B 1/14; E21F 1/04

(52) U.S. Cl. CPC B28B 7/0002; E21F 1/04; B66D 1/60; B28B 1/14

(57) ABSTRACT

A system for pouring concrete around a flexible duct assembly. The system includes a balloon deployment system for deploying and retracting a balloon system within the duct assembly. The balloon deployment system is displaceable along a length of the duct assembly and follows a level of concrete being poured therearound. A method for pouring concrete around a flexible duct assembly is also disclosed.

### FIELD OF THE INVENTION

The present invention generally relates to ventilation systems. More particularly, the present invention relates to a system and method of pouring concrete around a flexible ventilation duct assembly.

### BACKGROUND OF THE INVENTION

Ventilation ducts installed in mining raises or chutes can result in energy savings for ventilation systems installed in mining sites.

Tests have shown that the friction coefficient or K factor of ventilation ducts described in CA 2,677,432 is generally range of 2.25 to 5, as opposed to K factors 95 for bore holes into rock, 19 for steel ducts or 17 for fibreglass. These lower friction coefficients in the ducts result in energy savings as fewer or less power-consuming ventilation systems are required to displace a same amount of air through the ducts.

However, the ventilation ducts described in CA 2,677,432 are made of flexible materials. If one wishes to reinforce the area around the ventilation duct with concrete, the pressure of the concrete tends to collapse the ventilation duct assemblies

Therefore, in light of the aforementioned, there is a need for a system and method of pouring concrete around a flexible ventilation duct assembly which, by virtue of its design and components, would be able to provide better structural support for the duct assembly for the duct assembly during the pouring operation.

Excavated voids between two levels of a mine are seldomly perfectly vertical. Consequently, when one attempts to lower a ventilation duct assembly within a vertical excavated void through lowering cables, contact between the duct assembly and the exposed surface of the excavated void is frequent and can damage the duct assembly during its deployment along the length of the excavated void.

Therefore, in light of the aforementioned, there is a need for a system and method of deploying a flexible ventilation duct assembly within an excavated void which, by virtue of its design and components, would be able to reduce damaging contacts between the duct assembly and the excavated void during deployment of the duct assembly therein.

### SUMMARY OF THE INVENTION

An object of the present invention is to provide a system and method of pouring concrete around a flexible duct assembly that addresses at least one of the above-mentioned needs.

An object of the present invention is also to provide a system and method of deploying a flexible duct assembly within an excavated void that addresses at least one of the above-mentioned needs.

According to the present invention, there is provided a system for pouring concrete around a flexible duct assembly. The system includes a balloon deployment system for deploying and retracting a balloon system within the duct assembly. The balloon deployment system is displaceable along a length of the duct assembly and follows a level of concrete being poured therearound.

In some implementations, the balloon system includes first and second balloon sub-assemblies, wherein each balloon subassembly is independently deployable and retractable with respect to the duct assembly to allow the balloon deployment system to follow the rising level of poured concrete around the duct assembly.

In some implementations, the system further includes a detection device to detect the level of concrete being poured around the duct assembly.

In some implementations, the detection device comprises a flexible cable resistivity sensor.

According to the present invention, there is also provided a method for pouring concrete around a flexible duct assembly comprising:
installing the duct assembly within an excavated void;
placing, within the duct assembly, a balloon deployment system for deploying and retracting a balloon system within the duct assembly;
pouring concrete in a space around the duct assembly; and
displacing the balloon deployment system along a length of the duct assembly and to follow a level of concrete being poured therearound.

In some implementations of the method, the balloon system comprises first and second balloon sub-assemblies, wherein each balloon subassembly is independently deployable and retractable with respect to the duct assembly and the step of displacing the balloon system comprises selectively retracting a lower balloon subassembly once a lower portion of poured concrete has reached a predetermined level of solidification.

According to the present invention, there is also provided a system for deployment of a duct assembly within an excavated void comprising:
a lowering system for lowering the duct assembly within the excavated void; and
a cable guide system for guiding the duct assembly along a length of the excavated void.

In some implementations, the lowering system comprises first and second lowering cables removably affixable to the duct assembly.

In some implementations, the cable guide system comprises a guide cable slidably affixable to the duct assembly.

In some implementations, the system further includes a plurality of lowering cable brackets provided around a periphery of the duct assembly and attachable to the lowering cables.

In some implementations, the system further includes a plurality of guide cable brackets provided around a periphery of the duct assembly and being slidably attachable to the guide cable.

In some implementations, the system further includes a ring assembly affixable around the duct assembly and supporting the cable brackets.

In some implementations, the system further includes a conical nose assembly affixable at a front extremity of the duct assembly and shaped to guide travel of a front portion of the duct assembly along the excavated void.

According to the present invention, there is also provided a method for deploying of a duct assembly within an excavated void comprising:
lowering the duct assembly within the excavated void; and
guiding the duct assembly along a length of the excavated void using a cable guide system.

In some implementations, the method further includes, before the lowering step:
deploying a guide cable along a length of the excavated void;
assembling the duct assembly progressively from a plurality of smaller duct segments, each duct segment comprising a bracket ring assembly, lowering cable brackets and guide cable brackets, the cable brackets being supported by the bracket ring assembly and removably connected thereto; and
for each connected duct segment:
   affixing the lowering cable brackets to lowering cables; and
   installing the guide cable bracket such that the cable guide passes through a slidable opening of the guide cable bracket.

The components, advantages and other features of the invention will become more apparent upon reading of the following non-restrictive description of some optional configurations, given for the purpose of exemplification only, with reference to the accompanying drawings.

### BRIEF DESCRIPTION OF DRAWINGS

FIG. 1 is a schematic view of a system for pouring concrete around a flexible duct assembly according to an embodiment of the present invention.

FIG. 2 is a schematic view of a system for pouring concrete around a flexible duct assembly according to another embodiment of the present invention.

FIGS. 3a to 3c are schematic views of a system for pouring concrete around a flexible duct assembly according to another embodiment of the present invention.

FIG. 4 is a schematic view of an excavated void between two levels in a mine.

FIG. 5 is a schematic view of an excavated void between two levels in a mine.

FIG. 6 is a front view of components of a system for deployment of a duct assembly within an excavated void according to an embodiment of the present invention.

FIG. 7 is a front view of components of a system for deployment of a duct assembly within an excavated void according to an embodiment of the present invention.

FIG. 8 is a perspective view of components of a system for deployment of a duct assembly within an excavated void according to an embodiment of the present invention.

FIG. 9 is a detailed view of components shown in FIG. 8.

FIG. 10 includes schematic views of components of a system for deployment of a duct assembly within an excavated void according to an embodiment of the present invention.

FIG. 11 includes schematic views of a duct assembly according to an embodiment of the present invention.

FIG. 12 includes schematic views of cable guide brackets according to an embodiment of the present invention.

FIG. 13 includes schematic views of lowering cable brackets according to an embodiment of the present invention.

FIG. 14 includes schematic views of a ring assembly according to an embodiment of the present invention.

FIGS. 15 to 19 include schematic views of subcomponents of a ring assembly according to an embodiment of the present invention.

FIG. 20 includes schematic views of a coupling for a ring assembly according to an embodiment of the present invention.

FIGS. 21 and 22 include schematic views of a conical nose assembly according to an embodiment of the present invention.

FIG. 23 includes schematic views of a tube according to an embodiment of the present invention.

FIGS. 24 and 25 include schematic views of templates according to an embodiment of the present invention.

### DESCRIPTION OF PREFERRED EMBODIMENTS

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present invention illustrated in other figures can be easily inferred therefrom. The embodiments, geometrical configurations, materials mentioned and/or dimensions shown in the figures are optional, and are given for exemplification purposes only.

Furthermore, although the present invention may be used with various objects, such as ventilation ducts in mine raises or chutes, for example, it is understood that it may be used in other types of environments. For this reason, expressions such as “mine”, “raise” or “chute” etc. as used herein should not be taken as to limit the scope of the present invention to these applications in particular. These expressions encompass all other kinds of materials, objects and/or purposes with which the present invention could be used and may be useful, as can be easily understood.

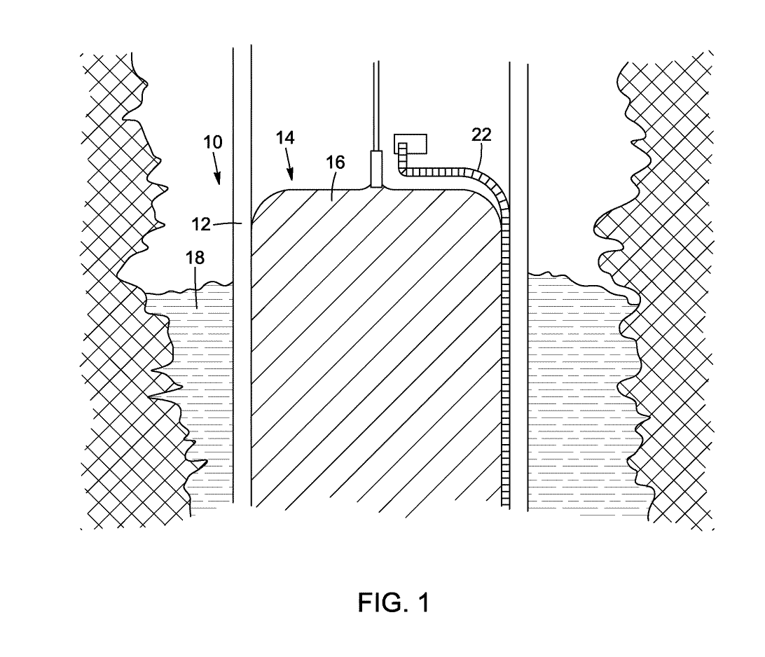

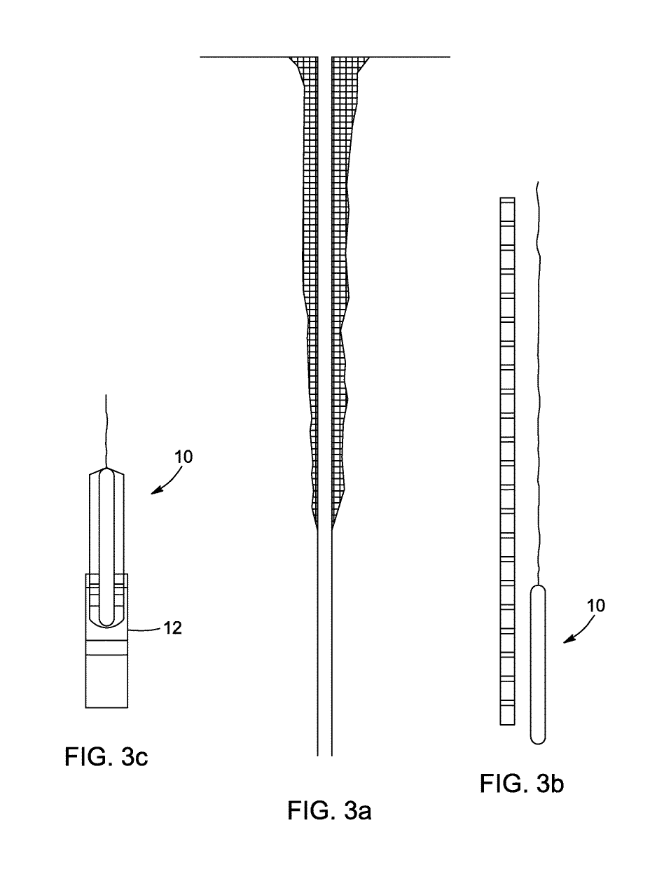

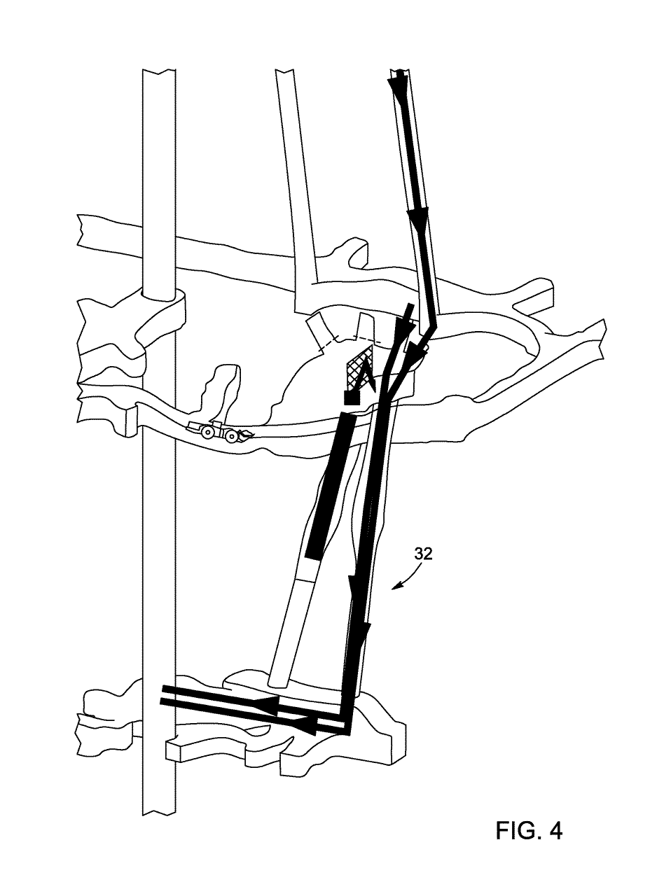

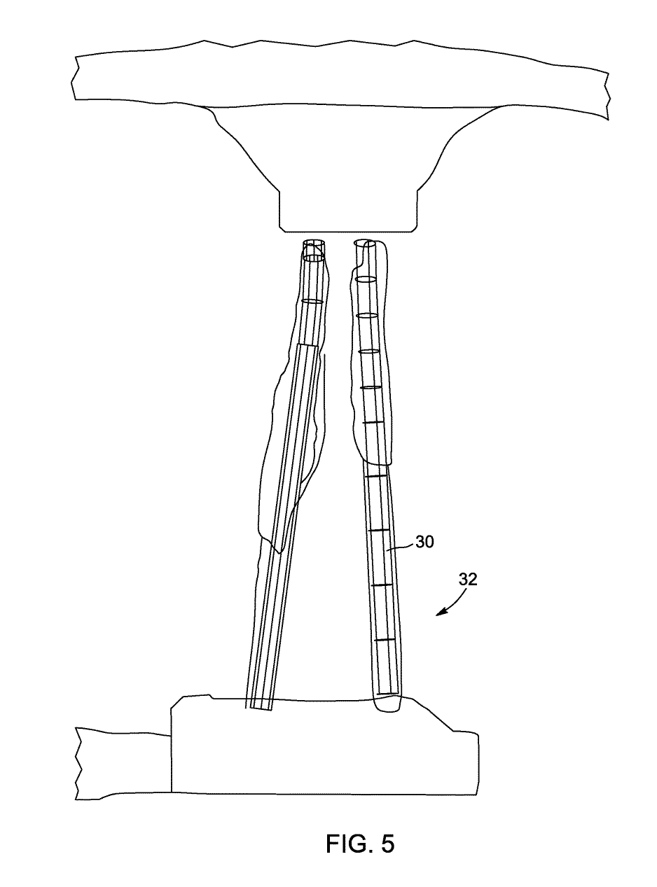

As shown in FIGS. 1 to 3, there is provided a system 10 for pouring concrete around a flexible duct assembly 12. The system includes a balloon deployment system 14 for deploying and retracting a balloon system 16 within the duct assembly 12. The balloon deployment system 14 is displaceable along a length of the duct assembly and follows a level of concrete 18 being poured therearound.

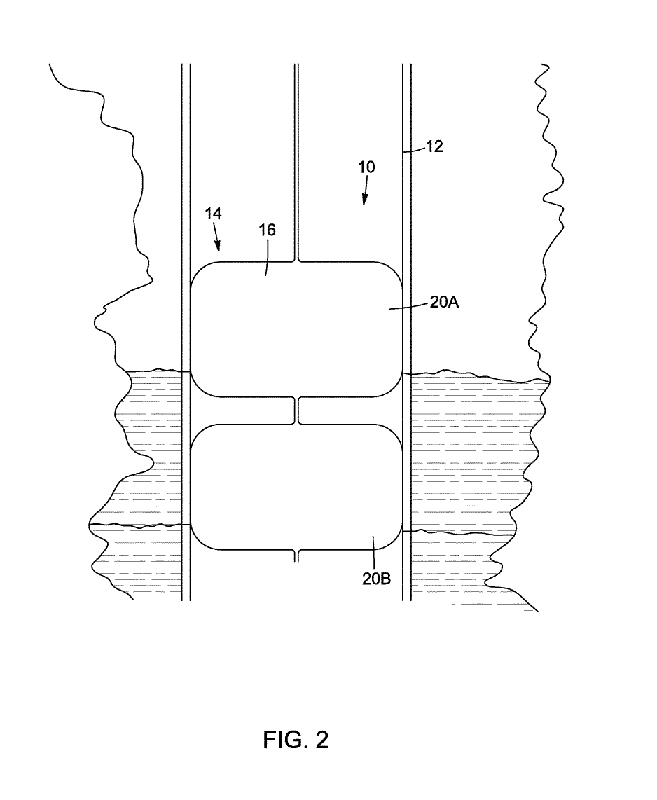

In some implementations, as better shown in FIG. 2, the balloon system 16 is made of rubber and includes first and second balloon sub-assemblies 20A,20B, wherein each balloon subassembly is independently deployable and retractable with respect to the duct assembly 12 to allow the balloon deployment system to follow the rising level of poured concrete around the duct assembly.

In some implementations, as shown in FIG. 1, the system further includes a detection device 22 to detect the level of concrete 18 being poured around the duct assembly.

In some implementations, the detection device 22 comprises a flexible cable resistivity sensor.

According to the present invention, there is also provided a method for pouring concrete around a flexible duct assembly comprising:
installing the duct assembly within an excavated void;
placing, within the duct assembly, a balloon deployment system for deploying and retracting a balloon system within the duct assembly;
pouring concrete in a space around the duct assembly; and
displacing the balloon deployment system along a length of the duct assembly and to follow a level of concrete being poured therearound.

In some implementations of the method, the balloon system comprises first and second balloon sub-assemblies, as shown in FIG. 2, wherein each balloon subassembly is independently deployable and retractable with respect to the duct assembly and the step of displacing the balloon system comprises selectively retracting a lower balloon subassembly once a lower portion of poured concrete has reached a predetermined level of solidification.

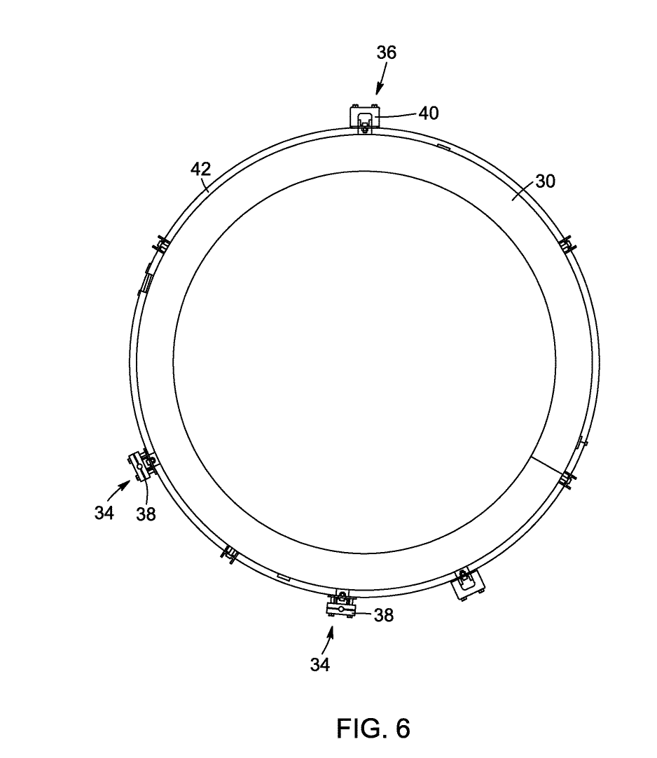

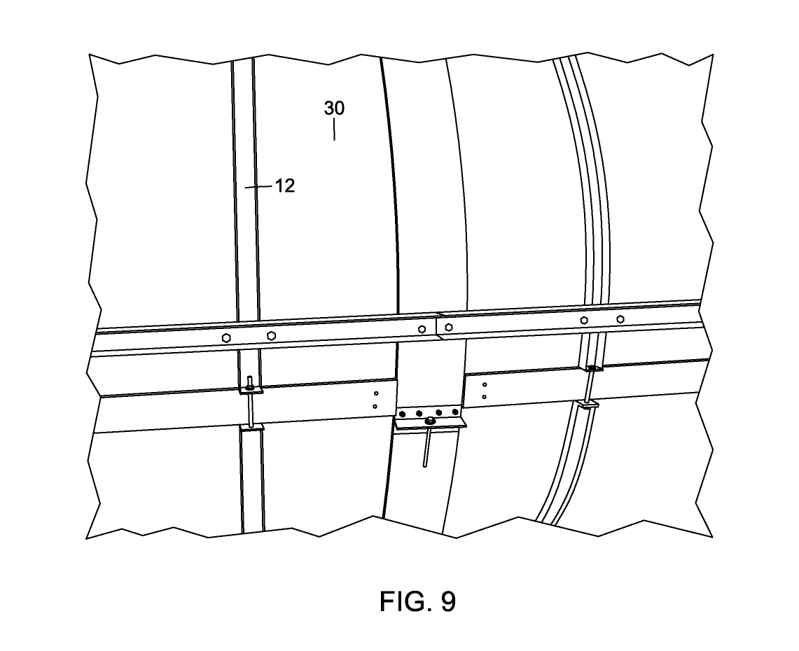

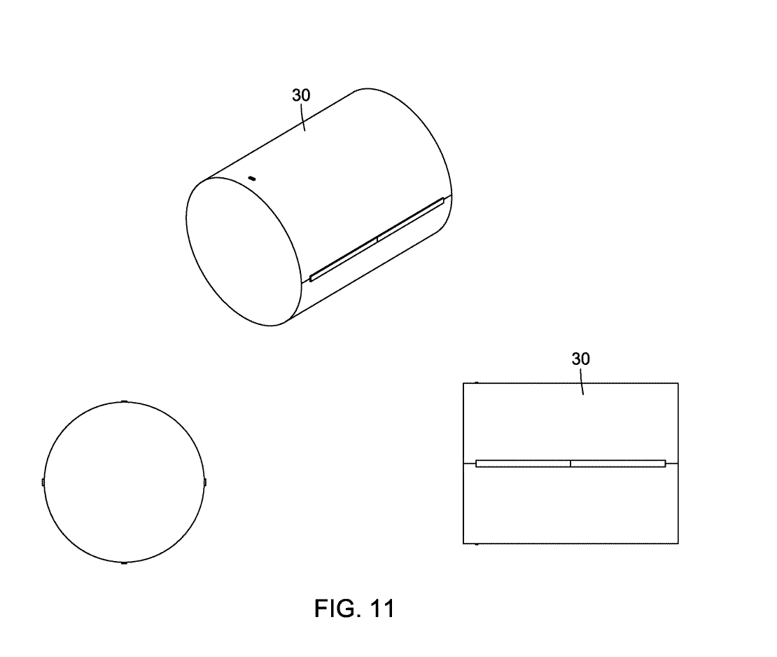

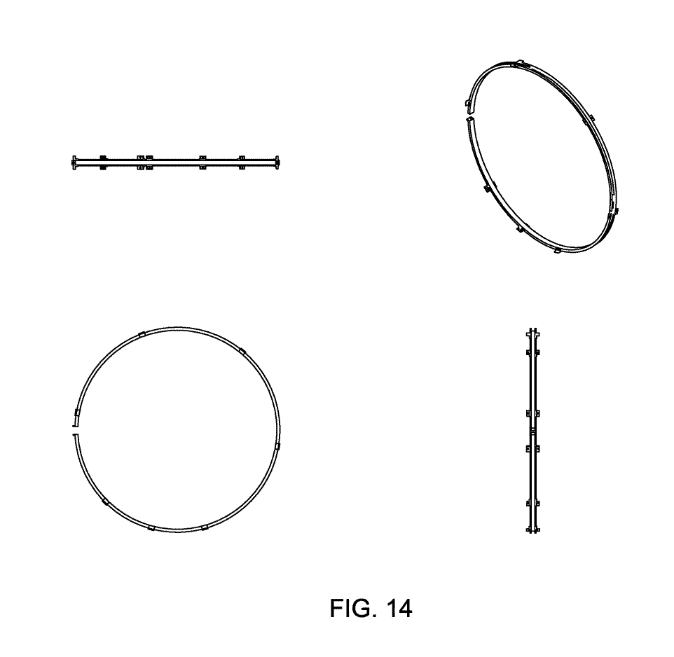

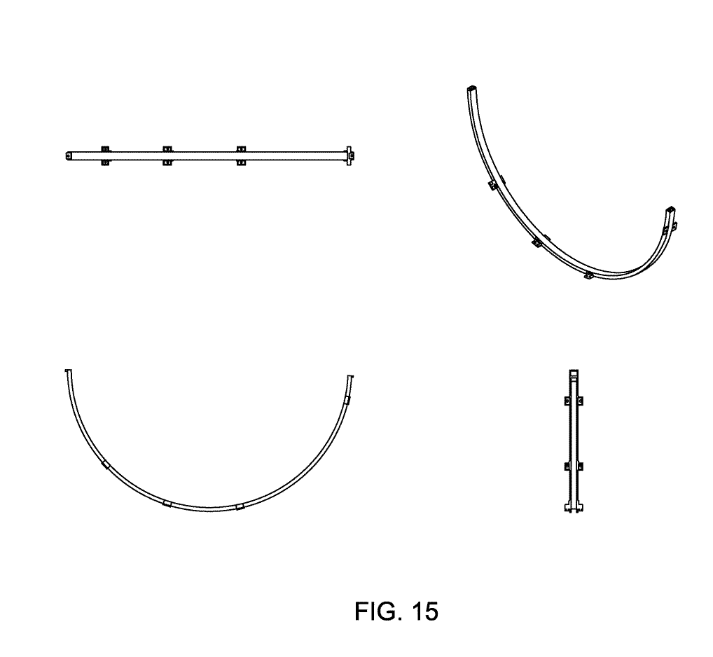

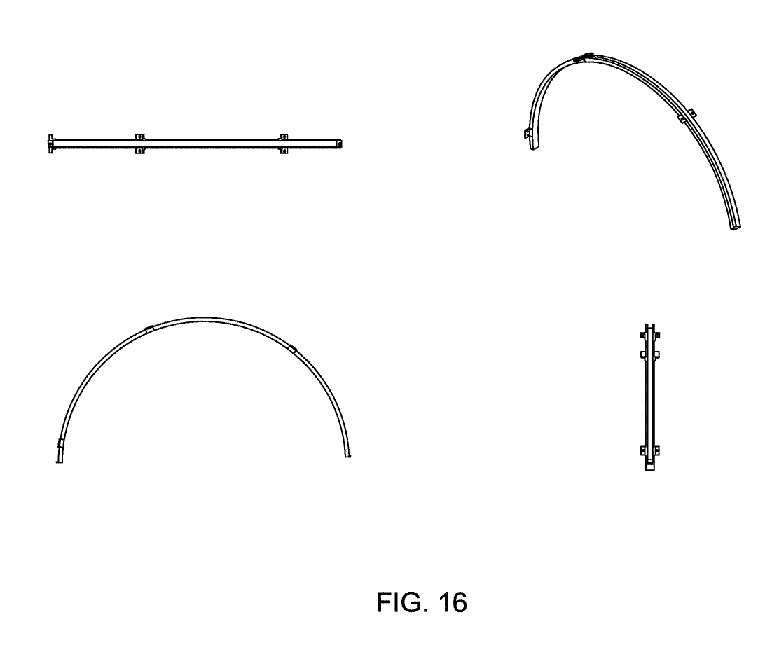

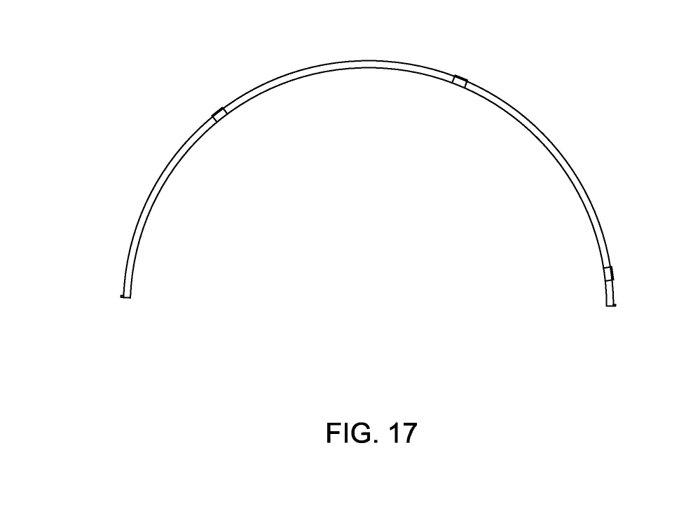

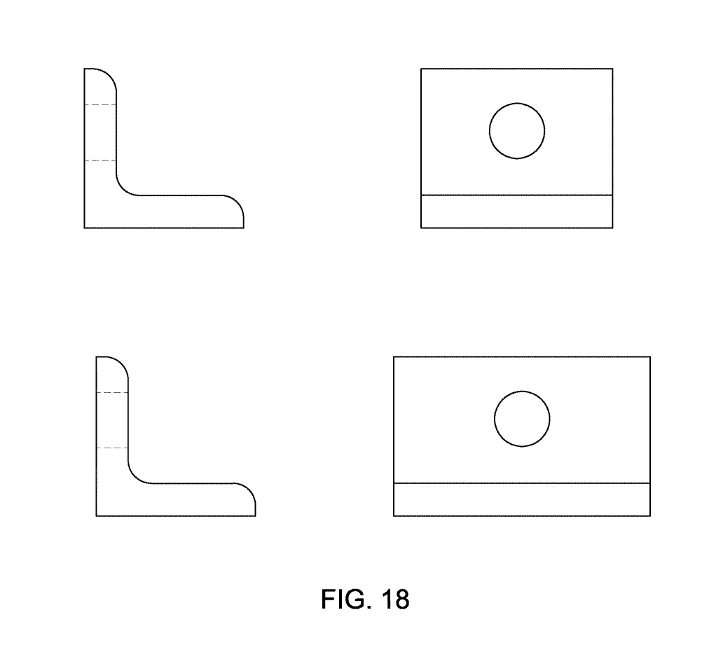

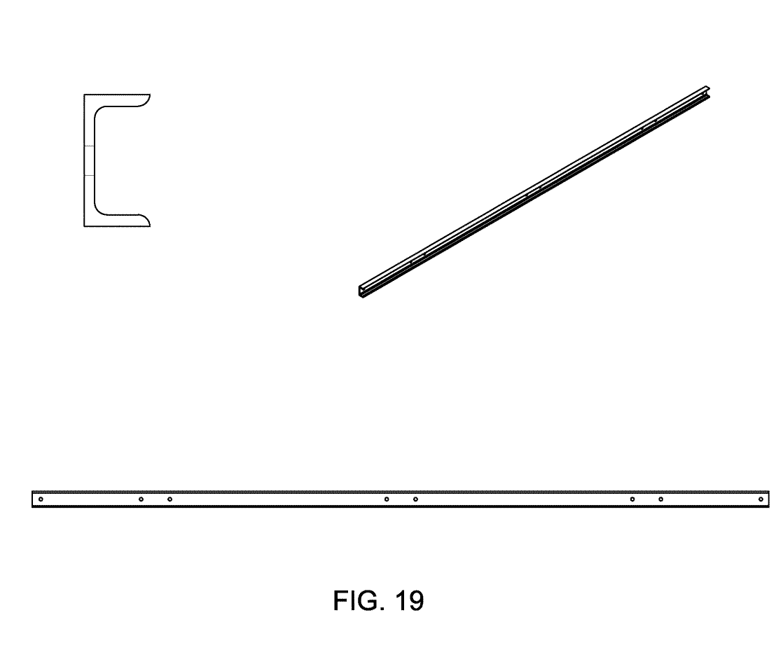

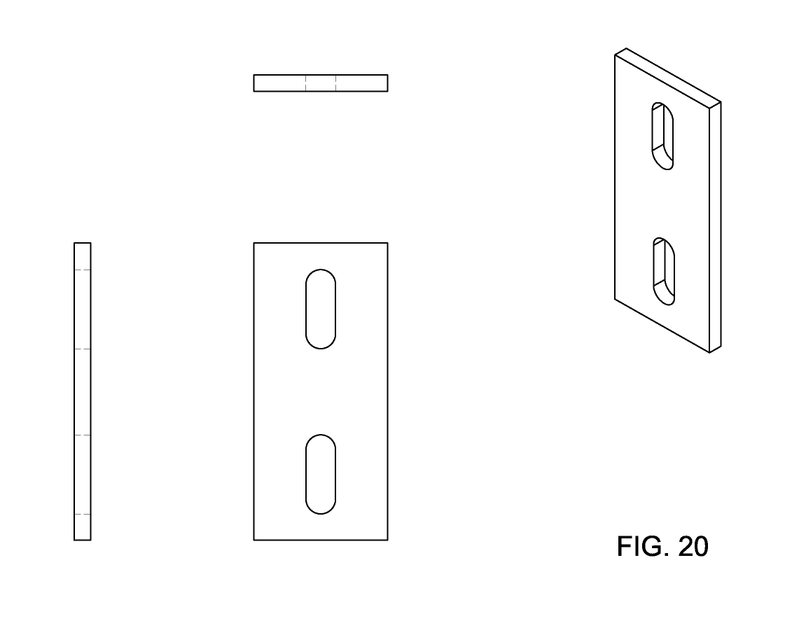

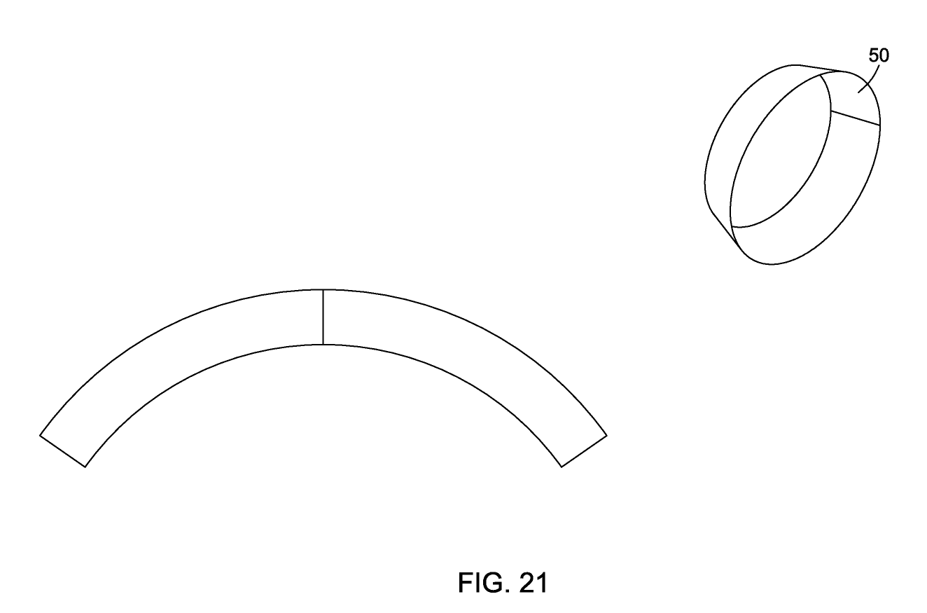

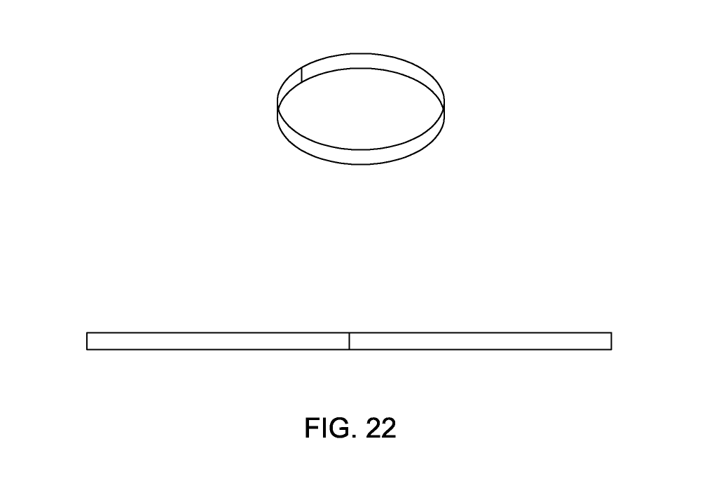

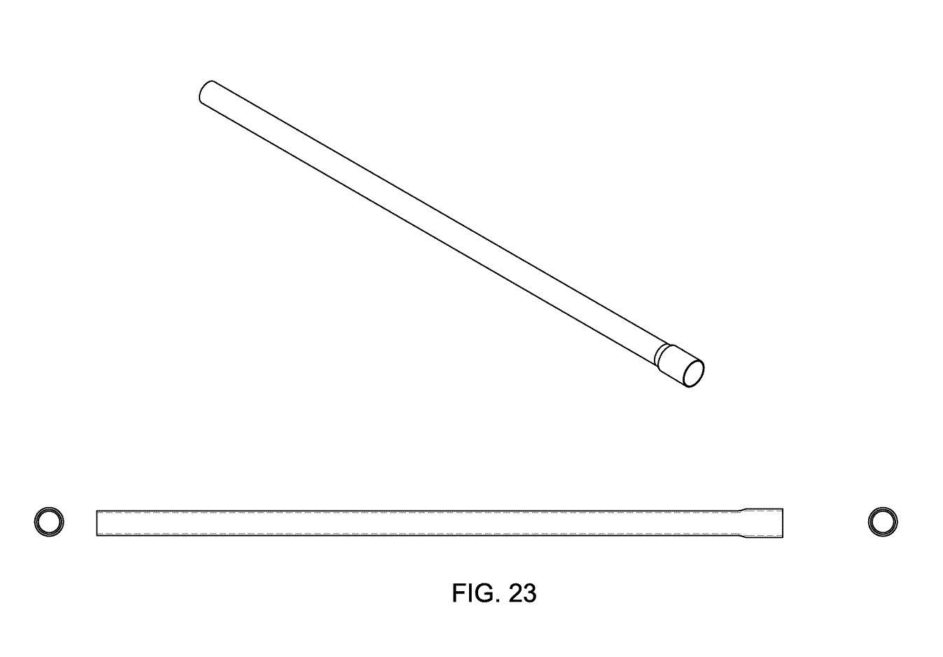

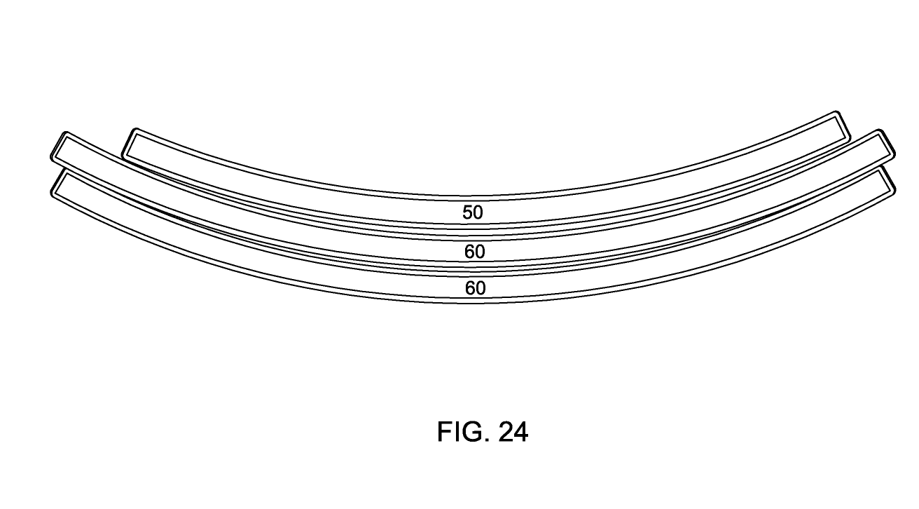

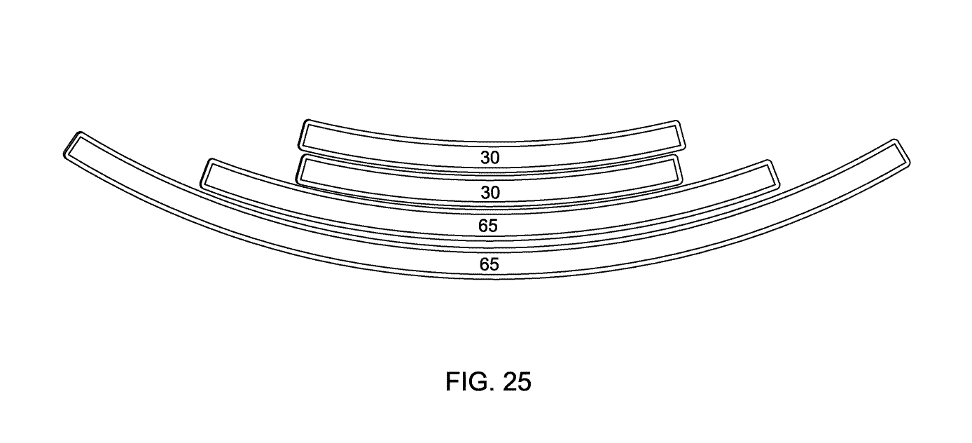

According to the present invention, as shown in FIGS. 6 to 25, there is also provided a system for deployment of a duct assembly 30, such as the ones described in CA 2,677,432 incorporated herein by reference, within an excavated void 32 comprising:
a lowering system 34 for lowering the duct assembly within the excavated void; and
a cable guide system 36 for guiding the duct assembly 30 along a length of the excavated void.

In some implementations, the lowering system 34 comprises first and second lowering cables removably affixable to the duct assembly 30.

In some implementations, the cable guide system 36 comprises a guide cable slidably affixable to the duct assembly 30. Preferably, the guide cable is adjustably tensioned.

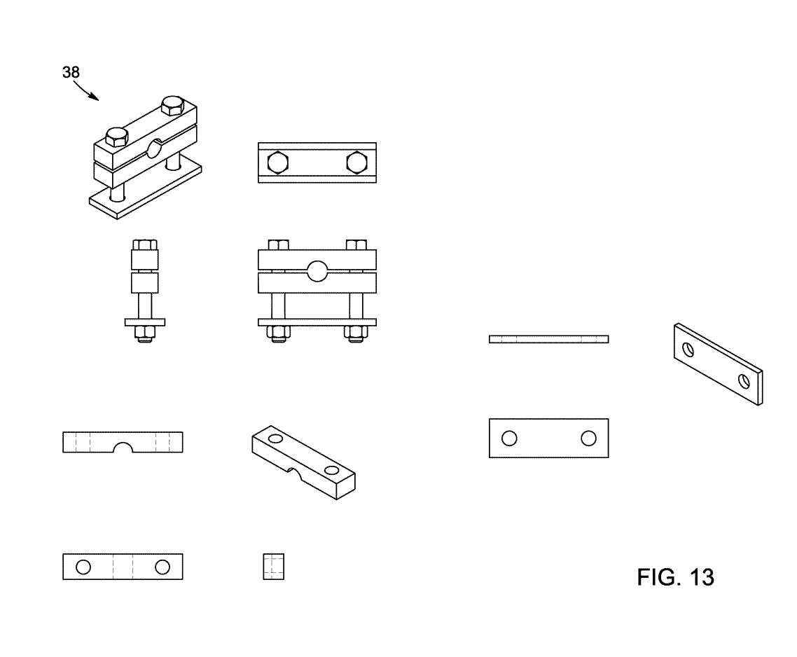

In some implementations, the system further includes a plurality of lowering cable brackets 38 (illustrated in FIG. 13) provided around a periphery of the duct assembly 30 and attachable to the lowering cables.

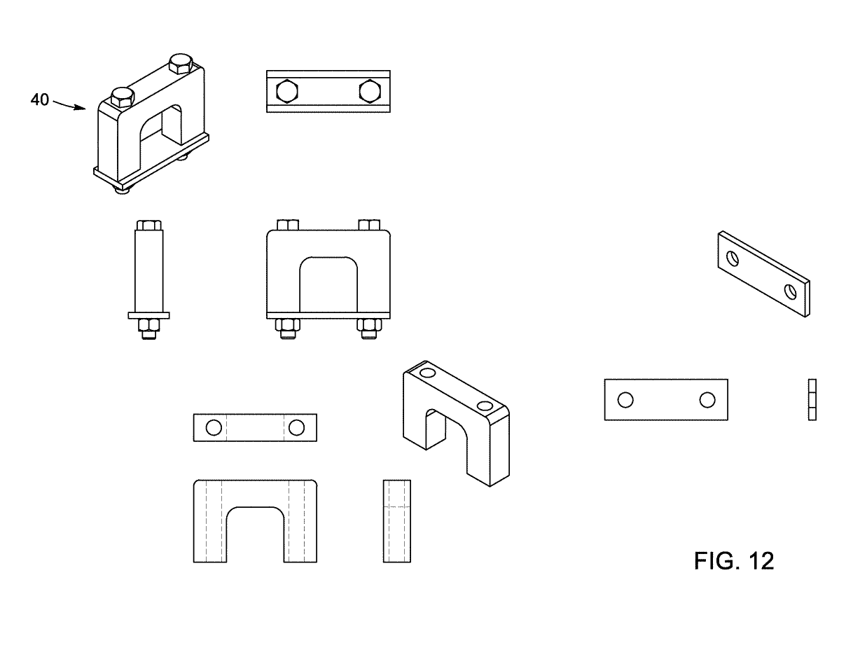

In some implementations, the system further includes a plurality of guide cable brackets 40 (illustrated in FIG. 12) provided around a periphery of the duct assembly and being slidably attachable to the guide cable. At the beginning of the lowering of the duct assembly, the cable guide brackets can be positioned along the length at shorter intervals that space out as more of the duct assembly is descended in the excavated void.

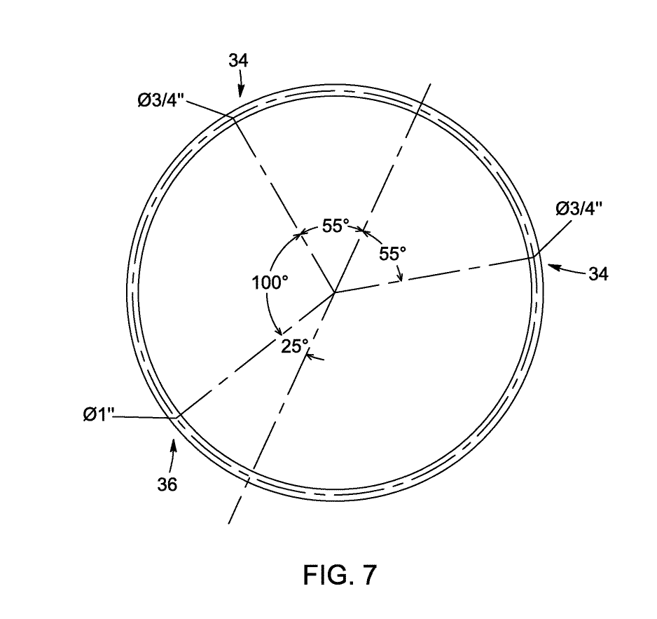

The angles illustrated in FIG. 7 between the lowering cables and the guide cable can be varied depending on the specific application.

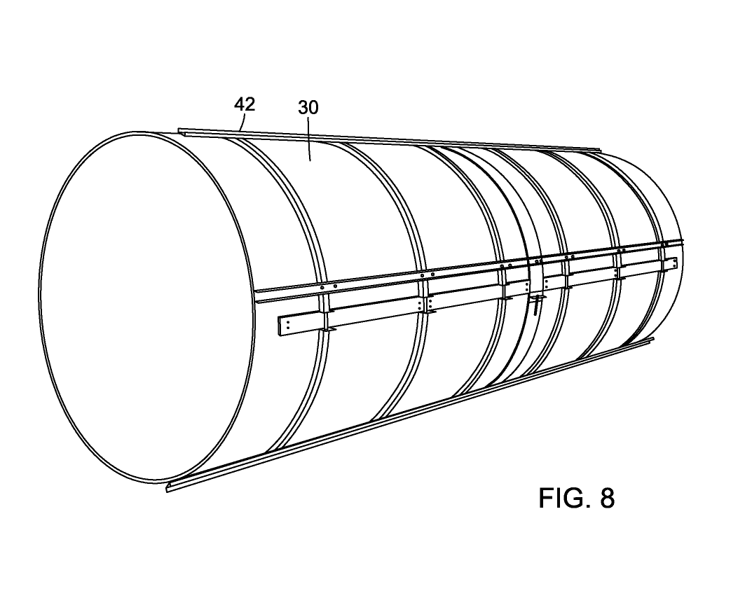

In some implementations, as better shown in FIGS. 8 to 10 and 14 to 19, the system further includes a ring assembly 42 affixable around the duct assembly and supporting the cable brackets.

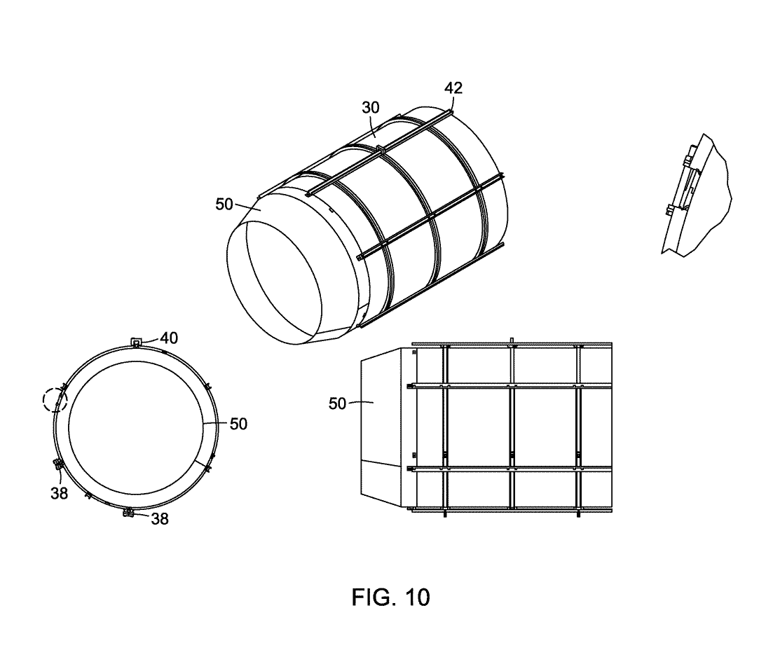

In some implementations, as better shown in FIGS. 10, 21 and 22, the system further includes a conical nose assembly 50 affixable at a front extremity of the duct assembly and shaped to guide travel of a front portion of the duct assembly 30 along the excavated void.

According to the present invention, there is also provided a method for deploying of a duct assembly within an excavated void comprising:
lowering the duct assembly within the excavated void; and
guiding the duct assembly along a length of the excavated void using a cable guide system.

In some implementations, the method further includes, before the lowering step:
deploying a guide cable along a length of the excavated void;
assembling the duct assembly progressively from a plurality of smaller duct segments, each duct segment comprising a bracket ring assembly, lowering cable brackets and guide cable brackets, the cable brackets being supported by the bracket ring assembly and removably connected thereto; and
for each connected duct segment:
   affixing the lowering cable brackets to lowering cables; and
   installing the guide cable bracket such that the cable guide passes through a slidable opening of the guide cable bracket.

Of course, numerous modifications could be made to the above-described embodiments without departing from the scope of the invention, as defined in the appended claims.

1. A system for pouring concrete around a flexible duct assembly comprising:
a balloon deployment system for deploying and retracting a balloon system within the duct assembly,
wherein the balloon deployment system is displaceable along a length of the duct assembly and follows a level of concrete being poured therearound.

2. The system according to claim 1, wherein the balloon system comprises first and second balloon sub-assemblies, wherein each balloon subassembly is independently deployable and retractable with respect to the duct assembly to allow the balloon deployment system to follow the rising level of poured concrete around the duct assembly.

3. The system according to claim 1, further comprising a detection device to detect the level of concrete being poured around the duct assembly.

4. The system according to claim 3, wherein the detection device comprises a flexible cable resistivity sensor.

5. A method for pouring concrete around a flexible duct assembly comprising:
installing the duct assembly within an excavated void;
placing, within the duct assembly, a balloon deployment system for deploying and retracting a balloon system within the duct assembly;
pouring concrete in a space around the duct assembly; and
displacing the balloon deployment system along a length of the duct assembly and to follow a level of concrete being poured therearound.

6. The method according to claim 5, wherein the balloon system comprises first and second balloon sub-assemblies, wherein each balloon subassembly is independently deployable and retractable with respect to the duct assembly and the step of displacing the balloon system comprises selectively retracting a lower balloon subassembly once a lower portion of poured concrete has reached a predetermined level of solidification.

7. A system for deployment of a duct assembly within an excavated void comprising:
a lowering system for lowering the duct assembly within the excavated void; and
a cable guide system for guiding the duct assembly along a length of the excavated void.

8. The system according to claim 7, wherein the lowering system comprises first and second lowering cables removably affixable to the duct assembly.

9. The system according to claim 7, wherein the cable guide system comprises a guide cable slidably affixable to the duct assembly.

10. The system according to claim 8, further comprising a plurality of lowering cable brackets provided around a periphery of the duct assembly and attachable to the lowering cables.

11. The system according to claim 9, further comprising a plurality of guide cable brackets provided around a periphery of the duct assembly and being slidably attachable to the guide cable.

12. The system according to claim 10, further comprising a ring assembly affixable around the duct assembly and supporting the cable brackets.

13. The system according to claim 7, further comprising a conical nose assembly affixable at a front extremity of the duct assembly and shaped to guide travel of a front portion of the duct assembly along the excavated void.

14. A method for deploying of a duct assembly within an excavated void comprising:
lowering the duct assembly within the excavated void; and
guiding the duct assembly along a length of the excavated void using a cable guide system.

15. The method according to claim 14, further comprising, before the lowering step:
deploying a guide cable along a length of the excavated void;
assembling the duct assembly progressively from a plurality of smaller duct segments, each duct segment comprising a bracket ring assembly, lowering cable brackets and guide cable brackets, the cable brackets being supported by the bracket ring assembly and removably connected thereto; and
for each connected duct segment:
affixing the lowering cable brackets to lowering cables; and
installing the guide cable bracket such that the cable guide passes through a slidable opening of the guide cable bracket.

16. The system according to claim 1, further comprising a system for deployment of a duct assembly within an excavated void comprising:
a lowering system for lowering the duct assembly within the excavated void; and
a cable guide system for guiding the duct assembly along a length of the excavated void.

17. The system according to claim 16, wherein the lowering system comprises first and second lowering cables removably affixable to the duct assembly.

18. The system according to claim 16, wherein the cable guide system comprises a guide cable slidably affixable to the duct assembly.

19. The system according to claim 17, further comprising a plurality of lowering cable brackets provided around a periphery of the duct assembly and attachable to the lowering cables.

20. The system according to claim 19, further comprising a plurality of guide cable brackets provided around a periphery of the duct assembly and being slidably attachable to the guide cable.

21. The system according to claim 19, further comprising a ring assembly affixable around the duct assembly and supporting the cable brackets.

22. The system according to claim 16, further comprising a conical nose assembly affixable at a front extremity of the duct assembly and shaped to guide travel of a front portion of the duct assembly along the excavated void.
